(19) United States
(12) Patent Application Publication
(10) Pub. No.: US 2005/0253355 A1
(43) Pub. Date: Nov. 17, 2005

(54) Leverage-activated bicycle, leverage activated tricycle, leverage activated vehicle moved by electricity generated by human power

(76) Inventor: Maximo Gomez Nacer, West New York, NJ (US)

Correspondence Address: MAXIMO GOMEZ - NACER, APT: 1, 232, 67TH STREET, WEST NEW YORK, NJ, 07093, US

(21) Appl. No.: 10/842,796

(22) Filed: May 11, 2004

(51) Int. Cl. B62M 1/10

(52) U.S. Cl. 280/252

(57) ABSTRACT

The system and the method of providing an efficient human powered vehicle by means of using levers that transmit the force produced on them to a rotational mechanism making move one or more wheels to the driving wheels of an bicycle, tricycle or vehicle where the rotational mechanism might be enclosed inside a negative pressure chamber containing one or more multiplying gears in communication to an electricity generator which provides power to batteries which provide power to the engine that moves the vehicle which is equivalent to transforming the our biological force into mechanical force then into electrical and finally into movement.

### BACKGROUND OF THE INVENTION

The present invention generally relates to bicycles and human powered vehicles. Prior art within this realm are vast thought industry including the numerous shapes and designs widely used in the past and in the present.

The bicycle history became very interesting ever since 1817, when Baron von Drais invented a walking machine. The original design was composed of two same sizes in line wheels. The one in the front allowed steering in the desired direction and it was mounted on a frame to be straddled. The device was propelled by the action of the person riding on it by pushing the feet against the ground.

The development continued and by 1835 it was invented the double screw propeller while by 1836 it was invented the push pedal bicycle. In 1864 appeared the roller drive chain while the bicycle continued its evolution towards a velocipede, which made its appearance in 1865. By the same time it was invented the rotatory pedal so they were directly applied to the front wheel and latter on appeared the metal tires of the “boneshaker”. The next appearance was the large front wheel bicycle in 1870. By this time the metallurgic industry had developed sufficiently to provide metal, which was strong enough to make small, light parts out of. This was one of the first machines that appeared made entirely of metal. The pedals were still attached directly to the front wheel with no freewheeling mechanism. By this time the wheels became covered with solid rubber tires making a much smoother ride than its predecessor and the front wheel became progressively larger as they noticed the larger the wheel, the further you could go with one rotation of the pedals. The metallurgic industry continued to improve making possible the elaboration of fine metal strong enough to make a chain and sprockets small and light enough for a human being to power. By 1877 ball bearing were used in bicycles and by 1879 appeared the chain driven bicycle of Harry Lawson. Then the tricycle made its appearance as well and many mechanical innovations were added to the existing designs. Some examples are the rank and pinion steering, the differential, and the band brakes. The high wheel safety appeared as an improvement in the design, many with small wheel in the front to eliminate the problem of the lack of balance of prior designs that had the tendency to tipping forward.

A little later on appeared in Europe the derailleur for the chain, which paved the road for the future introduction of the multiple gearing mechanisms. The designs returned to the original configuration of two same size wheels and they were added some comfort features such as front and rear suspension. But with the appearance of the pneumatic tire (invented by Dunlop, an Irish veterinarian Doctor), much of those suspensions disappeared and comfort continued to improve while by 1898 a shaft drive emerged to dispense with the dirty chain. The manufacture industry continued to improve and mass production became a reality. Multiple models and new shapes became very popular. The emphasis was in the design rather than its practicality because the automobile industry was much more practical since it could move faster without a great deal of effort. But by the nineteen sixties the frames started to become leaner and simpler to allow a greater speed and performance. It is worth to mention the English three speed of the sixties and seventies and the ten-speed derailleur bikes of the seventies that became very popular and gave way to the more recent mountain bikes. Bicycling continued its constant increasing popularity and by 1984 this sport received an incredible boost after the televising of the Olympic games in Los Angeles which gave rise to the profitable business of bicycles accessories which has been a beneficial activity ever since.

The current market is still in progress. Numerous designs and accessories continue to appear and among them it is worth to mention the chainless bicycle that uses internal gearing and the two by two bicycle that uses the awd system for the double traction of the mechanism. This device uses a clutch located within a rear spiral gear and helps to control the transmission of the energy of the rear wheel to increase the frontal wheel grip.

As a general conclusion to this brief introduction I would like to add that Cycling saves on the cost of gas, automobile maintenance and parking, but more importantly it helps it and us to be healthier on the environment.

Now, despite the extent of known prior art in this field, a demand still exists in certain areas for the mechanism, which can enhance the efficiency of the application of the force of the muscle on the pedals which would give us the choice of using sprockets of a higher diameter (or inductor wheel) to transmit higher frequency to the smaller sprocket (or induced wheel) by means of a chain or other mechanism while increasing the speed of human powered transportation.

The standard designs used today do not allow the use of a bigger sprocket plate or inductor wheel because the axis for this device is located under the extremities of the rider at a very close distance to the ground. Furthermore the rider has to produce a wide range of muscle contraction that goes from cero degree to nearly one hundred and thirty five degrees angulations when completing the circular motion. By cero degree angulations I mean that the extremity of the individual is aligned vertically like for example when the leg is strait (as if standing) with the foot pressing down on the pedal (at the time when the extremity is closer to the ground). When I said one hundred and thirty five degrees I am talking about the angulations of the knee joint at the point when the pedal is coming back to the top position. This is something that we ordinarily do all the time when pedaling without even noticing, but the fact is that this movement produces stress on the knee joint that acts as a fulcrum for this articulation and this angulations are not anatomically favored. The knee joint in this case is the pivot that has stretched many of the ligaments in order to make this movement possible. Since this action is synchronized with the forward movement of the opposite leg we do not even notice the strain on the joint. The idea I want to address is that you can put more leg power into a longer travel linear pedal stroke than in a circular one and we can assist our knee joint effort by adding a pivot axis to the pedal in such a way that this point receives most of the stress necessary to produce the angular momentum. Since this new flat pedal concept not only improves the issue of the angulations of the knee but now the rider's weight assisted by gravity helps us to achieve a better power on a true lever of the new design.

This new design will have multiple uses as a recreational vehicle and as transport of humans and cargo and several applications in touristy, terrain or aquatic sports. The present application is more directed toward the ground vehicle although it is envisioned a very wide application including taking off the ground.

### SUMMARY OF THE INVENTION

The present invention provides a system and method for a better optimization of the force produced by the muscle contraction in order to move a mechanical device using human power. According to one embodiment of the present invention, a leverage-assisted bicycle, a leverage assisted tricycle, and a leverage assisted vehicle powered by human electricity generation are described comprising; a frame configured to be supported on the ground by at least two wheels. The design of the frame is done in such a manner that it allows the use of a bigger pedaling sprocket without getting in contact with the ground because its main axis is located at a more elevated position than the traditional bicycles. It may be located either behind or in front to the person pedaling (versus the standard bicycle when this axis for the long inductor wheel is between the lower limbs of the person limiting the space available). The frame has an additional axis (containing ball bearings) for receiving levers that acts as a vertical flat pedal producing a movement up and down. This movement is achieved because the levels have an axis close to its ends that is opposite to the place where we produce the pressure with our extremity in such a way that said axis has the function of a true fulcrum in order to exert increased force on the crank arm of the rotational mechanism by means of a link arm.

With the application of this design the person has to make less effort in order to produce a complete turn of the inducer's wheel because the force exerted on the arm is increased by the pivot axis of the level. The present configuration also allows for the use of multiple persons without having adding more rotational pedals to the bicycle. We can use one two or more individuals literally standing on the level or flat pedal and they all will produce pressure over it, which increase the force applied over the crank arm of the inducer's wheel. I have created the variable length frame consisting of concentric top tubes and concentric down tubes with holes on them in order to match with bolts that can be placed on a longer or shorter form according to the desired length of the frame. I have done this design In order to be able to add more persons to the current embodiment of this bicycle because once again, everyone can synchronously produce pressure on the level or flat pedal at the same time. This is expected to be fun for individuals that use this bicycle as a recreational device but is also a practical solution for families that use the bicycles even to commute because it will increase the horsepower of the bicycle without having to add more rotator pedals. The down tube might be attached to the head tube by means of an axis that might vary slightly the angulations according to the desired length of the down tube. The flat pedal or levels are designed also in such a manner that they can be extended to increase the length or shortened by means of bolts according to the amount of persons expected to ride. The top tube can have a different number of seat binder bolts in order to add seats for more persons. According to the present embodiment I have included only one seat attached to the top tube by the seat bolt. Under the seat bolt there is a middle tube that is designed to provide additional support to the frame and there might be as many middle tubes as needed according to the amount of persons expected to ride on the frame. The levers acts as foot supports for receiving the weight of the person. The rider or riders can increase the power on this leverage by the flexion contraction of the upper extremities against the handlebar, which will increase the force on the lever where the person is standing. There is also a strap placed around the foot and a grove on the lever in order to avoid displacement like for example caused by the slippery action of the rain. There is also a safety top at the end of the flat pedal for the same reason. The inductor wheel is connected to the smaller induced wheel by means of a chain or it can be in direct contact. The smaller gear may consist of several concentric sprockets in order to selectively alter the speed. The stepping motion of the individual (s) is translated into angular momentum by means of an arm link.

According to another embodiment of the present invention, a leverage-assisted tricycle is disclosed. The leverage assisted tricycle (LATY) is designed to achieve higher velocity and performance than standard tricycles used today because it can use the improved leverage action of pedals to exert increasing pressure over a rotational mechanism which will allow us to use higher ratio of inductor to induced wheels and it may be used for recreational or any other purpose. The vertical movement up and down of the longer pedal allows better human muscular power than the traditional circular movement. The LATY comprises a frame consisting of concentric tubes that can be adjusted as desired in order to allow more riders. And it is configured to be supported on the ground by three wheels rotatably attached to the same frame. The frame has at least one top tube, one down tube, one head tube and one back tube where the pivotal axis for the pedal is located in a approximate point of the union of the down and the back tube and where the axis for the crank arm of the inductor wheel (also known as the axis for the bigger plate of the chain) is located in an approximate point close to the union of the top tube and the back tube. The frame has at least also a head tube containing ball bearings inside for the movement of a fork that holds the front wheel where said head tube also contains a head set for the attachment of said fork as well as a handle bar and all the other additions of a standard bicycle. The frame has also at least a chain stay 8, and a pivotal axis stay 9, that converge at a triangular shape 39 in order to form a point for the attachment of the hubs of the rear wheels and it has at least a chain stay 8 consisting of two bars (right side and left side) moving in a close to parallel direction towards the back. The chain stays are attached on one end, to the axis of the inductor wheel; and on the other end, to the attachment point for the axis of the two rear wheels hubs or a point in the frame to provide support. The pivotal axis stay consists of two bars (right side and left side) moving in a close to parallel direction towards the back departing from the attachment point of the pivotal axis on one end towards either the attachment point for the axle of the two rear wheels or the frame of to the back seats The axle for the posterior wheels may be attached to two suspensions 40, which hold supporting tubes 41, for holding the passenger seats and the cover. The posterior passenger seats 42, may have a cover 38, to produce additional comfort to the passengers. The velocity is transmitted to the posterior axle 43 by means of a chain or pulley or belt 8, which connects the big wheel 20 to the smaller size wheel 21 of said axle 43. The axle 43 may provide movement to only one wheel or both. It is envisioned the potential use of a differential to facilitate steering. The big wheel 20 is moved bay the action of the crank arm 12 that is moved in turn by the action of the arm link 13 that is moved by the short arm of the pedal 16. There is a chain protector 17 and a floor 44 to support the feet of the passengers in the back seat. The rider seat 19, is supported by the top tube 2 of the frame that contains one or more seat-binding bolt 25 for the insertion of the seat post 26 and the seat. There are several ball bearings at the points of friction of the pivotal axis, the axis of the big wheel, the axis of the attachment point of the crank arm to the link arm and the axis for the attachment point of the link arm to the short arm of the pedal. This will decrease the resistant significantly.

These and other features, aspects and advantages of the present invention will become better understood with reference to the following drawings, description and claims.

### BRIEF DESCRIPTION OF THE DRAWINGS

FIG. 1 is a lateral view of a leverage-activated bicycle.

FIG. 2 is a superior view of a preferred embodiment of the present invention.

FIG. 3 is a posterior elevational view of the leverage-activated bicycle.

FIG. 4 is and anterior elevation view of the leverage activated tricycle.

FIG. 5 depicts a posterior view of the leverage-activated tricycle. FIG. 5b depicts three benches linked together by the posterior axel of the tricycle and attached to a base together

FIG. 6 depicts the specially designed posterior wheel of the tricycle. 6a depicts the lateral view, 6b depicts the frontal view, and 6c depicts the oblique view. 6d depicts a superior view of the multiplying mechanism specifically designed to generate electricity using human power.

FIG. 7 depicts a lateral view of the coupling mechanism or crankshaft that holds the big wheel with two axes for the multiplying mechanism. It also depicts the leverage action of four levels in its fulcrum and four links for the crankshaft.

FIG. 8a depicts a lateral view of two long levers (approximately five meter of length) powered by five persons. FIG. 8b depicts a superior view of the same two long levers.

FIG. 9 depicts a lateral elevation view of the same mechanism used to power a vehicle. (Leverage activated vehicle powered by human electricity generation).

FIG. 10 depicts a superior view of a similar vehicle using the same mechanism powered by ten persons using four longitudinal pedals or levers

FIGS. 11, 12 and 13 depict a method according to the present invention for the LABY, the LATY and the Leverage activated vehicle moved by electricity generated by human power.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention discloses a vehicle powered by human or leverage activated bicycle, which may be used mostly for personal and family recreational purposes. It also describe the leverage activated tricycle which may be also used for the same purpose but since it has a broader base it can be used for many other multiple uses including but not limited to transport of cargo and persons as a tourist attraction.

This vehicle may comprise a frame and at least two wheels attached rotatably to the frame. There may be at least two-foot supports or pedals, in rotational communication with at least one wheel of the vehicle. It should be understood that many different embodiments are envisioned with multiple designs and it may be used many other multiple additions without departing from the spirit of the present invention.

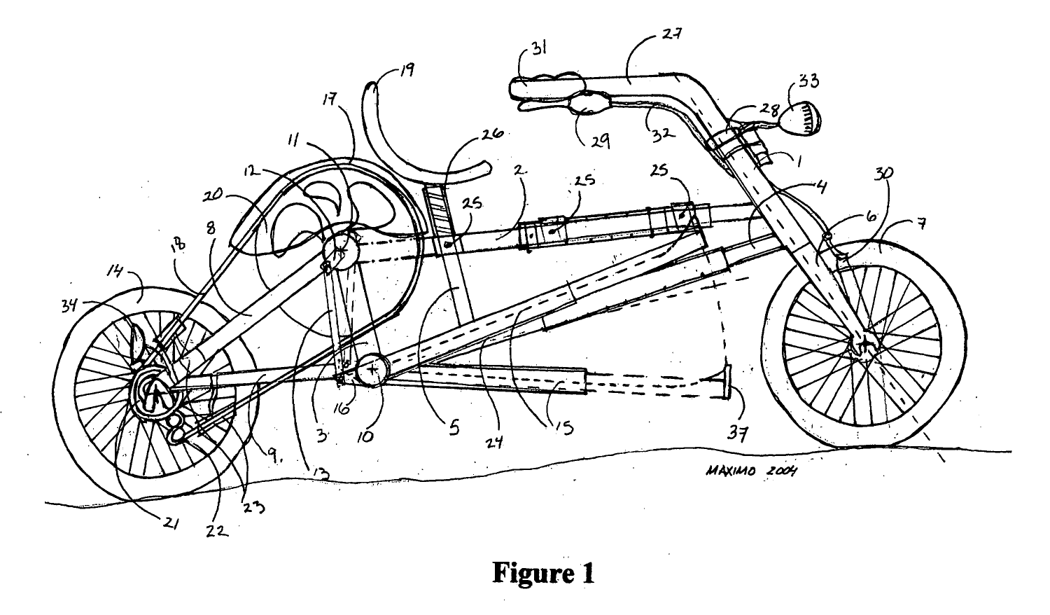

FIG. 1 is a lateral view of a leverage-activated bicycle. According to an embodiment of the present invention. The frame is configured to consist of a head tube 1, a top tube 2 which serves as a place for attachment of the seat or seats, a back tube 3, a down tube 4, and between none and three middle tubes 5. Middle tubes are not absolutely necessary but they are configured to provide additional support to the frame. The top tube and the down tube are expandable which is optional in case that we wanted to add more riders to the bicycle and in that case we can add additional middle tubes 5. The top tube contain at least on seat binder bolt 25, which is used to bind the seat post 26. The head tube contains ball bearings inside in order to facilitate the movement of the steering and the handle bar 27. Bellow the head tube there is a head set 28 that serves the function of binding the fork tube 6, to the head tube 1 of the frame. The fork tube 6, holds the front wheel 7. The frame has in its posterior part a chain stay 8 and a pivotal axis stay 9. There is a pivot axis for the levels or flat pedals 10, and an axis for the crank arm or inductor wheel axis 11. The pivotal axis 10 is located below the axis of the inductor wheel 11 and the posterior tube 3 binds them together. The crank arm per se 12 assists in moving the inductor wheel 11 by means of a link or arm 13 that connects the short arm of the flat pedal 16, to the crank arm 12. The chain stay 8 and the pivotal axis stay 9, both hold the posterior wheel 14. The levers or flat pedals than are attached to its main pivotal axis 10, consist of the long arm 15, and a short arm 16, which is very close to the distal end of the pedal in order to produce increasing force over the crank arm when the person stands on the opposite end of the long arm of the pedal. There is a chain guard 17, that protects the chain 18, while it connects the inductor wheel 20, to the induced wheel 21, There is also a power change mechanism 22 with a derailleur shift system 23 in order to mechanically move the chain from ring to ring. The long arm of the pedal 15 contain concentric expandable tubes 24, with pin groves in order to enlarge or decrease its size for the convenience of adding more riders to the bike. (This is optional)

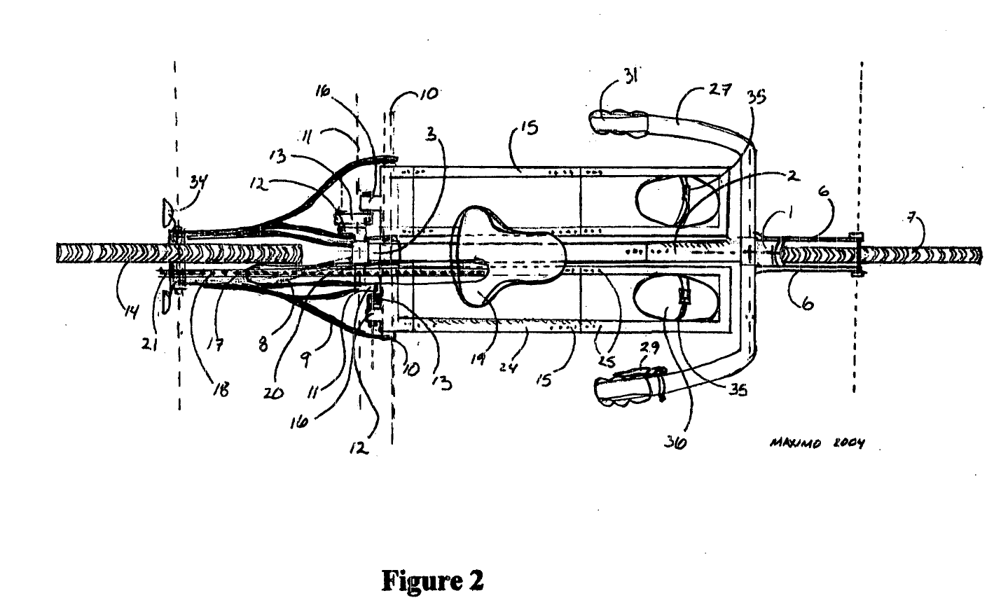

FIG. 2 is a superior view of a preferred embodiment of the present invention with the same description to the one corresponding to figure one.

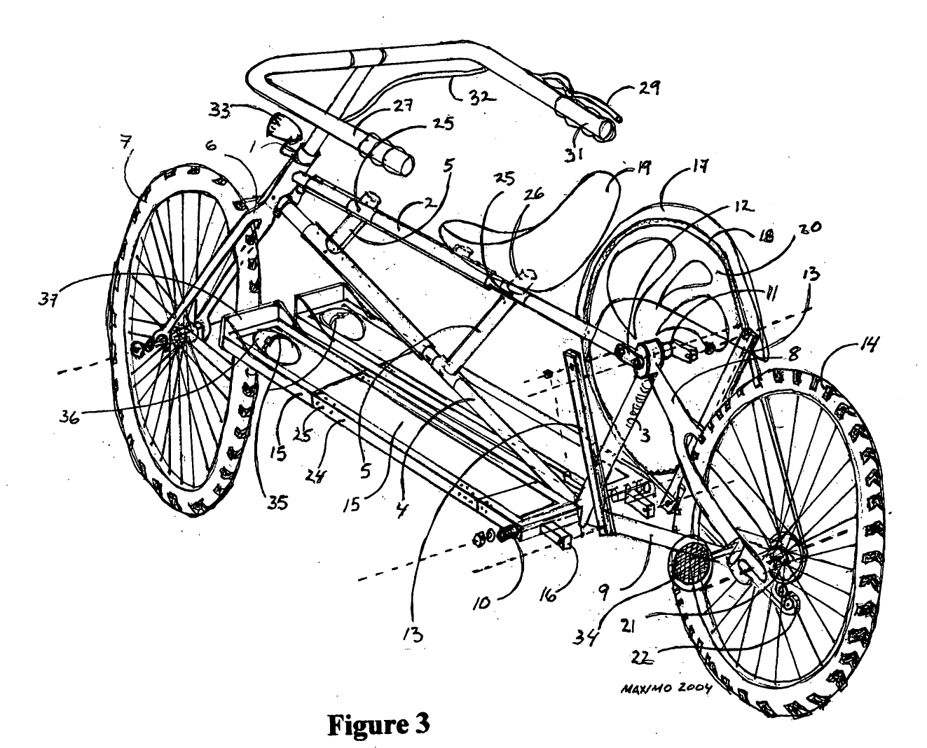

FIG. 3 is an posterior elevational view of the leverage activated bicycle. The numbers correspond to the same description given in the figure number 1. The handle brake lever 29 is represented in the handle bar 27. The brakes 30 are connected to the lever 29 by means of a brake cable 32. At the end of the handle bar there is a handle bar grip 31. There is also a frontal light or reflector 33 and back light reflector 34 as a safety feature. As another additional safety feature the pedals contain belts 35 for the attachment of the foot that are supported on a grove with the print like of the feet 36 and a front top 37 to avoid the foot from slipping out of the pedal.

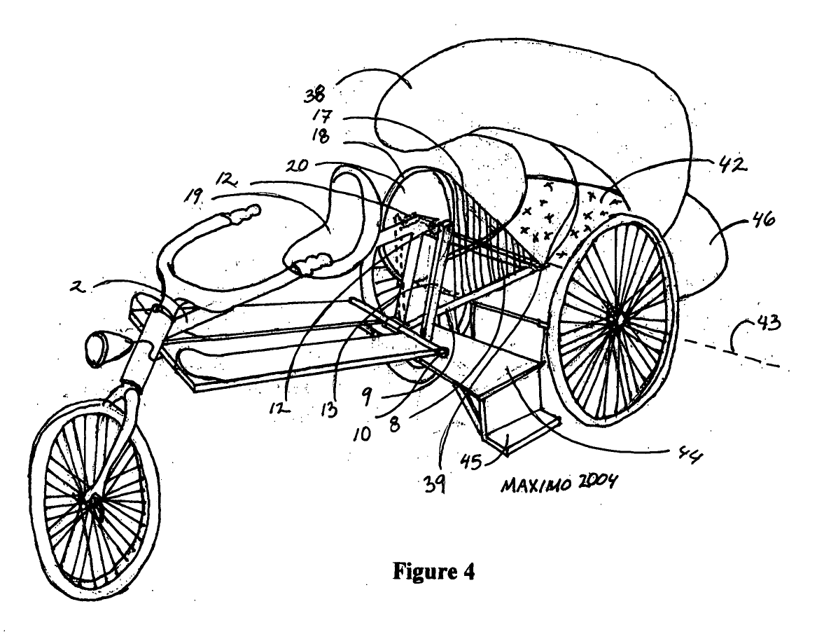

FIG. 4 depicts and anterior elevation view of the leverage activated tricycle. The cover 38 is created as an additional feature of comfort. The current design is intended as a touristy attraction but it can be designed to decrease the air resistance as well. The tricycle has passenger seats 42, and a floor 44 to support the passengers as well as a step 45. There is a trunk 46 to hold all the other parts that will be described with the electric generator. This is an advanced feature for a more expensive models and the configuration will be detailed in the following figure.

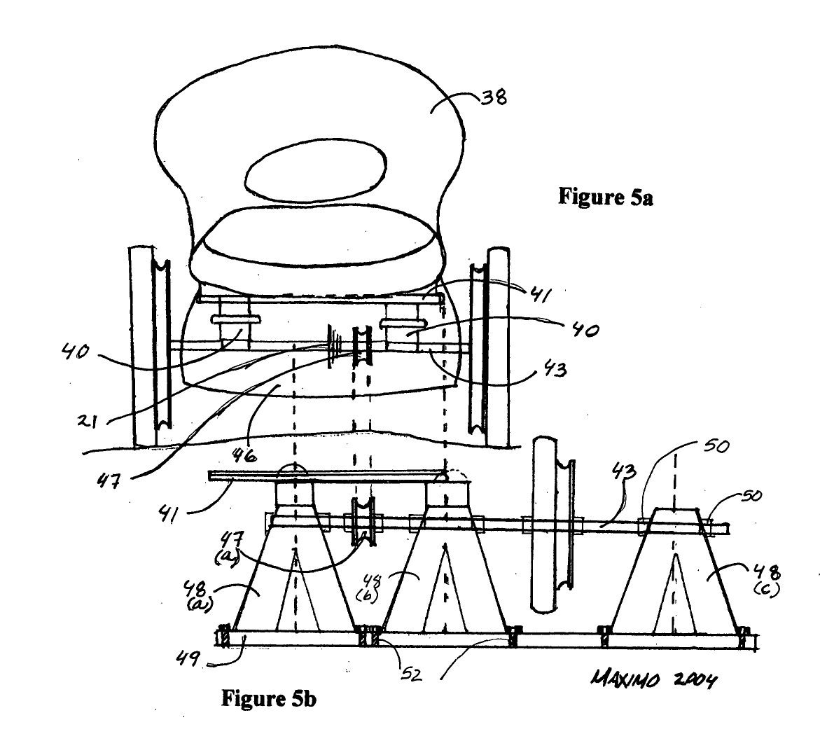

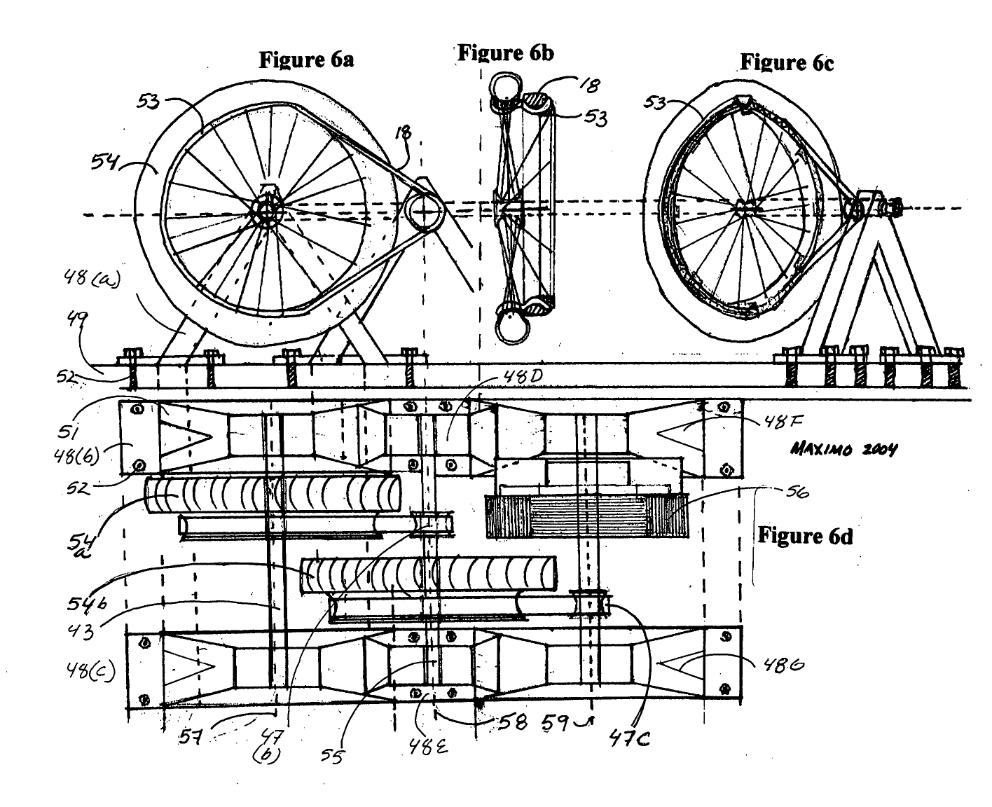

FIG. 5 The picture depicts a posterior view of the tricycle. It contain shock absorbers 40 that give support to the posterior axis 43 which contain the second set of gears 21 for modifying the speed and it can also have a holder for the pulley or belts 47 because they can be easily adapted the transmission. The gears may be shifted and translate to engage different sets of wheels. According to a preferred embodiment the coupling system is comprised of a first set of gears while the posterior axis 43 has the second set of gears. During the initial process for moving the vehicle, it may be desirable to have the second set of gear be the same size or the larger gear. However, once there is movement of the vehicle, it may be desirable to have the second set of gears be going as smaller as possible to achieve greater speed. The term larger is intended to denote having greater diameter. The gears should be uni-directional or reversible unidirectional. Reversible unidirectional is intended to denote gears that may be forward only and backward only. FIG. 5b shows the placement of three consecutive workbenches 48 or points of support aligned with the posterior axis 43. The workbenches are specially designed with ball bearings inside in such a way that we can insert the axle 43 in them and keep it in place using bolts 50. The workbenches 48 are joined together by a base or support 49. Every bench has a triangular shape and four legs 51 with leg bolts 52 at the end to match screws coming from the base or support 49. The base of support consists of several easy to assemble bars that form a rectangular shape when they are together (FIG. 6d). The base aligns three benches in two rows. The function of the base is to hold in place the benches that hold the multiplying wheel. When we tighten the bolts 52 every wheel is in the ideal position and this avoids any displacement or misalignment. The different multiplying gears will be kept in the ideal place in order to facilitate a smooth running of all the ball bearings of the wheels that will allow us to generate electricity. We are forming three axles. The first is the posterior one that uses the same posterior axle of the tricycle. Please note that we are using the same wheel that moves the tricycle that in this case has a special design with a belt holder 53 at the side of the tire. The idea is to be able to use this vehicle as a recreational one (when we go camping for example) and at the end of the trip we can generate our own electricity anywhere we go. Since the voltage geration depends on a great portion to the rotations per second, then we are using for this purpose the same wheels that move the vehicle. These wheels are ideal because they are as light as the ones of an ordinary bicycle and they can have a good diameter (for example forty inches), which will help us to produce a decent amount of electricity. For this reason we are placing the frame of the tricycle on benches. Please note that the benches are attached to the tricycle using groves under the frame of the tricycle that holds the posterior seats. We can lock the anterior wheel of the tricycle also using the same base used to assemble the multiplying mechanism. The bars that form the base for this multiplying mechanism are assembled easily and they can be easily stored on the trunk 46 of the tricycle (where we can store the alternator, batteries, etc as well).

FIG. 6 depicts the details of the wheels to be used with the multiplying mechanism for the generator. FIG. 6a depicts the lateral view of the posterior wheels of the tricycle. FIG. 6b depicts the frontal view. FIG. 6c depicts the oblique view. These wheels have a lateral grove 53, that holds the pulleys. I recommend the use of a pulley rather than a chain because it offers less resistance to the movement (ex, no pivots) and they weight less so they can be easily carried in the trunk. FIG. 6d depicts a superior view of the base for the multiplying system. As it is depicted, it forms a rectangular shape but it is envisioned to have any shape. Please note that the benches 48 or supports for the wheels are lettered according with the same order they should be placed on the base. The benches are aligned in three columns. Column one forms the first axle. It has Benches 48a, 48b and 48c. Benches 48a and 48b go under the tricycle in order to fix it to the base of the multiplying system. This is to be done on a not moving design. Between 48b and 48c of the first axle we attach the first wheel of the tire. For simplicity we are using the same axle 43 of the posterior wheels in order to multiply the velocity. (Again this is the static or non-moving design). The second column forms the second axle 55 that runs between the benches or points of support 48d and 48e. We place in this axle a small diameter (example two inches of diameter) pulley holder 47b and the second wheel of the tire 54b. Finally we have the last axle or third axle, which corresponds to the drive shaft of the alternator or an electricity generator or similar 56. It is placed between the benches 48f and 48g. There is a small diameter pulley holder 47c (for example measuring two inches of diameter) in this axle. If our inductor wheel has a diameter of twenty inches and the induced wheel has a diameter of two inches, then according to the diameters of the wheels described above we can produce theoretically four thousand revolutions per second which can give us a beautiful capability to generate electricity. The difficultly would be to find the materials with enough resistance to the heat and vibration to be able to use it but it can be done. In a similar way we can use the same mechanism with the addition of an alternator in order to produce alternate current and a convector in order to modify and further store the electricity produced. It is envisioned the use of as many multiplying gears as materials available to resist that friction without departing from the present invention. The function of generation of electricity is expected to be useful in situations like camping again or going to areas without electricity. It is envisioned also the use of said electrical current to power an electrical motor that can move in turn the vehicle without departing from the spirit of the present invention. The following figure will describe this concept more in detail.

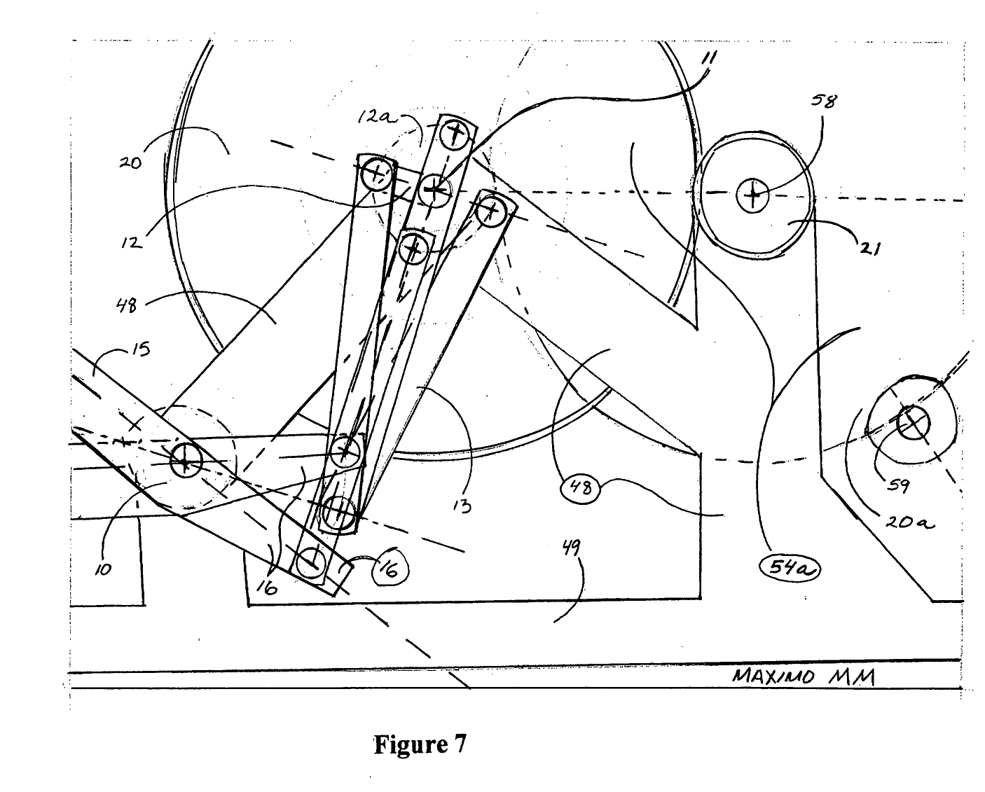

FIG. 7 depicts a lateral view of the multiplying mechanism where the main axis 11 of the coupling mechanism or crankshaft that holds the big wheel 20 (by big I mean more than one meter of diameter and it is implicit the fact explained before that all the axis contain ball bearings in order to decrease the resistance). It is very desirable a proportion of at least one hundred to one between the inductor and the induced wheel of subsequent axis (for example 58 and 59 as depicted in the present drawing) but it is envisioned the use of any combination of sizes or proportions between the inductor and the induced wheel used for this specific purpose of generation of electricity powered by human force without departing from the present invention. The concept of inductor wheel is the first wheel that produces the movement to the subsequent wheel that is called induced one. In the second axis we have two wheels, one small 21 (induced from 20) and another one big 54a that forms part of the same axel and rotates at the exact same revolution of 21. The subsequent induced wheel 20a in the picture would be the wheel that runs in axel 59. The axel 59 corresponds to the drive shaft for the alternator or electricity generator axis. It is envisioned of this axis to multiply as well further more the velocity without departing from the present invention. The picture represents also one crank arm 12 that moves a crankshaft (12a) of the main axis for the big wheel 20 in direct communication with the short arm of the lever 16 by means of a crank arm link 13. (The picture depicts four crank arm links 13 with angulations of ninety degrees between the attachment points for each of those links. Ninety degrees is the expected angulations for these crankshaft but it is expected the addition of more crank arms (as many as people we wanted to move the levers that move the crank arms) without departing from the present invention. The structure that provides support to the entire sets of axis is the frame 48. The frame connects the axis of the fulcrum 10 to the axis 11 of the first wheel 20 to the axis 58 of the second big wheel 54a(or also 20a in another pictures) to the axis of the next wheel 59. In this drawing it is depicted the combined action of four crank arms 12 working synchronously in order to make rotate the crankshafts 12a that moves the first inductor wheel.

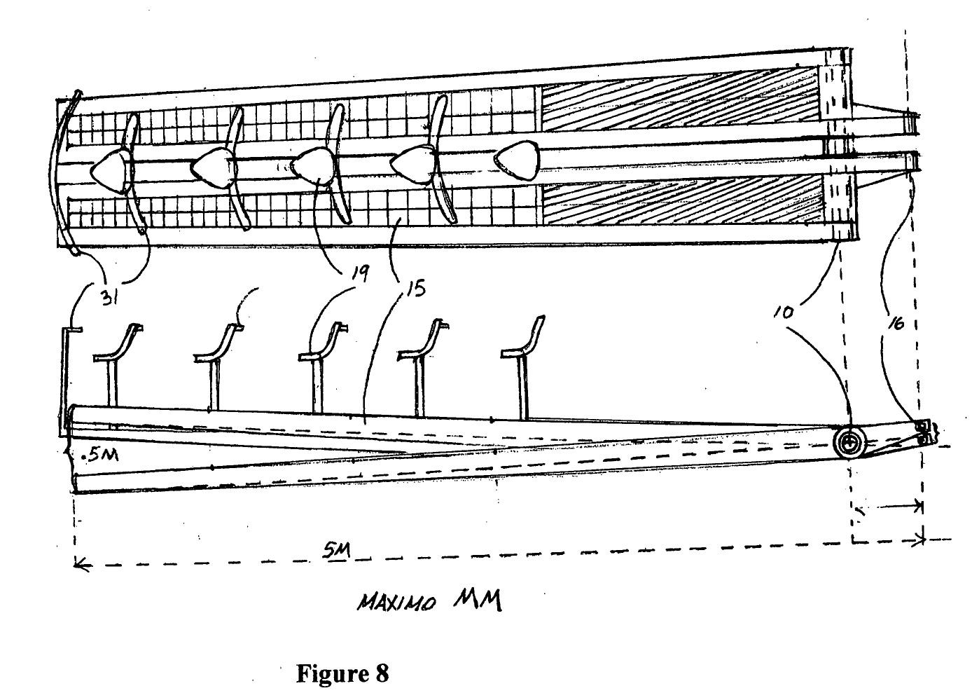

FIG. 8 depicts a lateral view of two long levers (approximately five meter of length) powered by five persons. FIG. 8b depicts a superior view of the same two long levers. The seats 19 are obviously attached to the frame and not to the pedals or levers.

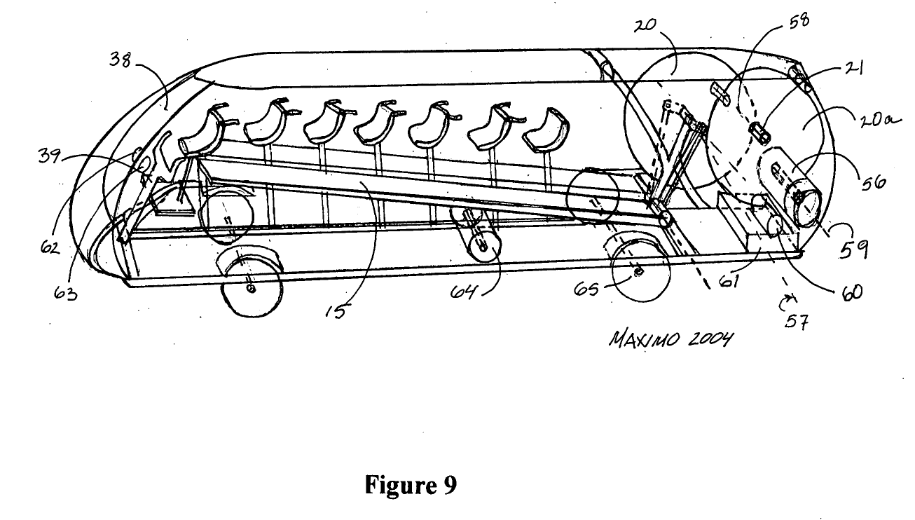

FIG. 9 depicts a lateral elevation view of the Leverage activated vehicle moved by electricity generated by human power. Please note that the alternator or electricity generator 56 gets its power after the multiplication of the force by the leverage action of the mechanism. We are using the force of more than one person but the number person powering the device can be one or more without departing from the present invention. There is a converter 60 and batteries 61 that power the electrical motor 64 that moves the vehicle. The vehicle in this case has four wheel 65 but it is also envisioned the use of up to 20 wheels without departing from the current invention. There is a control panel 62 with different measuring devices 63, and receivers and microprocessors 63 for the optimum function of the vehicle. There are several seats aligned in the same direction of the levers.

The use of the seats is variable without departing from the present invention. The levers consist of the same concept levers described before but with a much longer long arm in order to be able to produce bigger force on the crank arms 12 (the crank arms move the axis 57 and a much bigger wheel 20 (for example having a diameter of eighty inches). This bigger wheel is connected to a second axis 58 that has a smaller wheel or sprocket 21 (that may have two inches of diameter). The second axis 58 moves in its axel the small wheel 21 and a second bigger wheel 20a (for example having a diameter of eighty inches) which in turn is connected to a third axis 59 which moves the drive shaft of the alternator or electricity generator 56, that may be connected to a converter 60 which in turn is connected to a battery or batteries 61, which in turn is connected to a voltage regulator 62d electric switch 63, which in turn is connected to a motor 64 or turbine 64 that provides movement to the wheel that move the vehicle. The vehicle has also a cover 38 designed in aerodynamically way to protect from the elements and to help the vehicle to take off the ground.

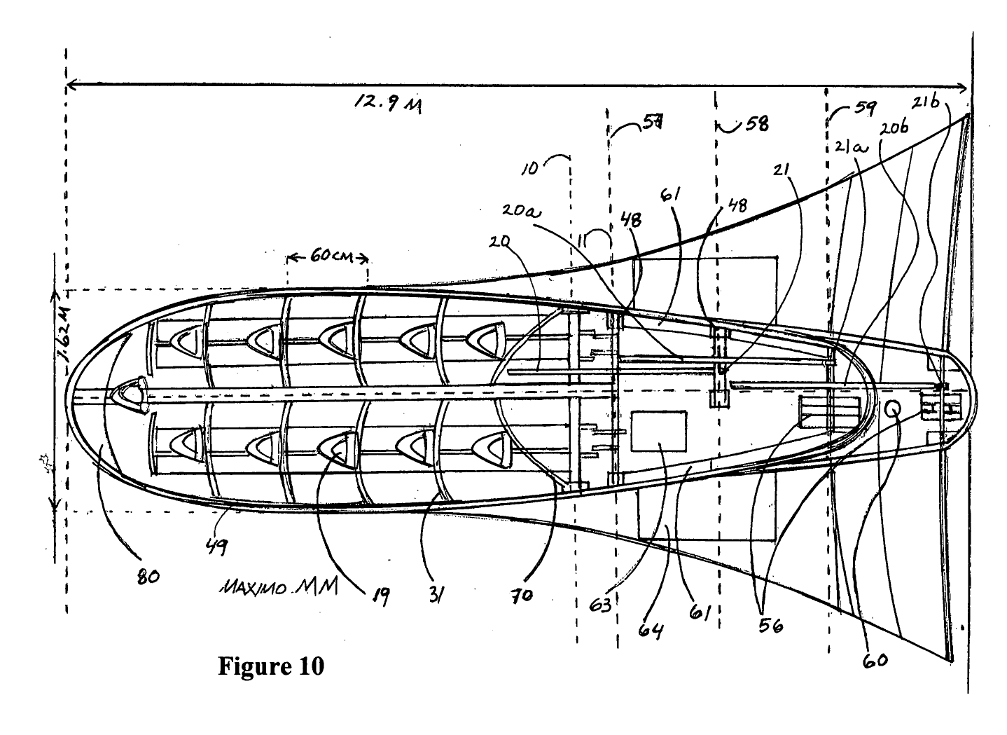

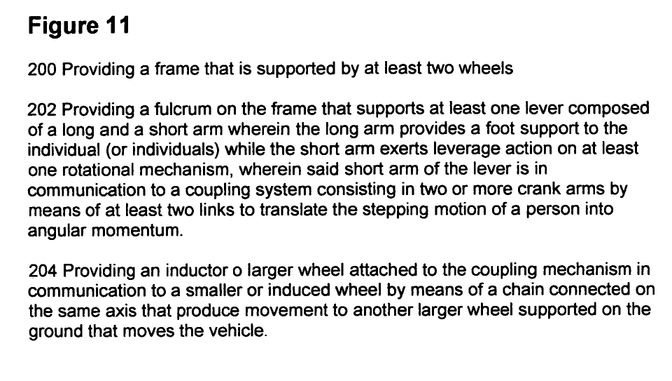

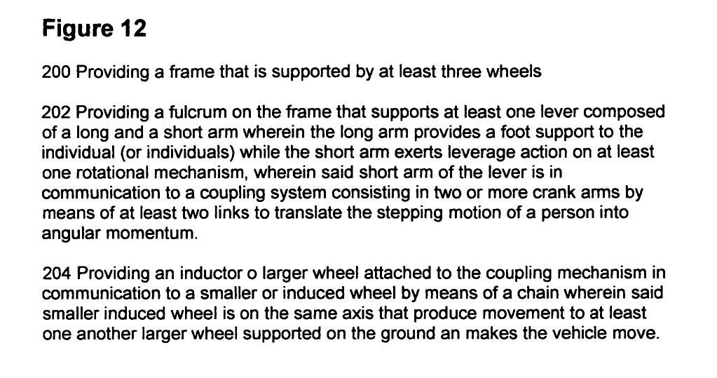

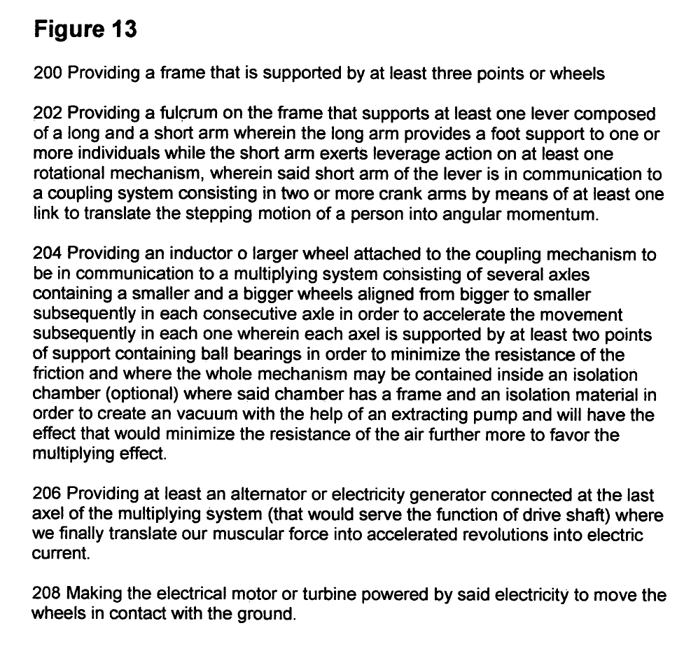

FIG. 10 depicts a superior view of the Leverage activated vehicle moved by electricity generated by human power ready to take off the ground. The control panel is represented with the letter 80. The drawing also depicts the mechanism in the posterior part of the device after an insulation wall 70 in order to create a vacuum chamber 71 to improve the movement of the wheels. If we keep a proportion of one hundred to one for every wheel in the axis 57, 58, 59, then we can produce at least in theory one million revolutions per second, which would be enough to generate in theory the electricity that powers a turbine 64 of an aircraft.

Other standard features required to move such as steering 39, the brakes, lights and all other standard features of the modern auto mechanical industry or transport industry in general. We can assist the movement of this vehicle with an improved rotational device or crankshaft where we can use as many levels as people available to move them. It is envisioned the use of several rows of seats (for example four) where the people can work together in a team effort to produce the mechanical advantage of the levers over the crankshaft in a synchronous way. The use of more than two levels will provide a smoother ride because it will exert a more uniform pressure over the crankshaft of the mechanism. It is envisioned the need of the use of insulation materials in order to avoid electrocution. It is envisioned the use of different sizes and amounts of multiplying gears aligned in different mode without departing from the present invention. It is also envisioned the use of different diameters in the size of the multiplying wheels without departing from the present invention. Humans can generate electricity in the same way that automobiles do it and we do not need much effort in order to prove it.

A system and method for increasing the velocity of a human powered device. According to a preferred embodiment, there may be a frame; two wheels rotatably attached to the frame. The frame has two main axis, one for the leverage action of the pedals and one for the rotational mechanism assisted by a crank arm and link arms to connect both axis. The pedals are pushed by the action of our weight and the muscle contraction of our body supported by the handlebars against the pedals since we can put more leg power into a longer travel linear pedal stroke than in a circular one. The pedals move up and down exerting leverage action at a plurality of distance from an axis that serves as a fulcrum to produce increased pressure over the opposite shorter end of the lever. The up and down movement of the levers or pedals assisted by our own gravity offers more human power transferred to its short end that makes rotate the rotational device where we can find an inductor wheel that transfers its energy to another one smaller wheel and from there to the wheels that move the vehicle. It is envisioned the use of different sets of gearing to alter the speed according to our needs.

According to yet another preferred embodiment of the invention there may be a frame; three wheels rotatably attached to the frame. The frame has two main axis, one for the leverage action of the pedals and one for the rotational mechanism assisted by a crank arm and link arms to connect both axis. The pedals are pushed by the action of our weight and the muscle contraction of our body supported by the handlebars against the pedals since we can put more leg power into a longer travel linear pedal stroke than in a circular one. The pedals move up and down exerting leverage action at a plurality of distance from an axis that serves as a fulcrum to produce increased pressure over the opposite shorter end of the lever. The up and down movement of the levers or pedals assisted by our own gravity offers more human power transferred to its short end that makes rotate the rotational device where we can find an inductor wheel that transfers its energy to another one smaller wheel and from there to the wheels that move the vehicle. It is envisioned the use of different sets of gearing to alter the speed according to our needs.

According to yet another preferred embodiment of the invention there may be a frame; supported on the ground by at least three wheels rotatably attached to the frame where at least one wheel supported by the ground is in communication to a rotational mechanism that moves the vehicle. The frame has two main axis, one for the leverage action of the pedals and one for the rotational mechanism assisted by a crank arm and link arms to connect both axis. The pedals are pushed by the action of our weight and the muscle contraction of our body supported by the handlebars against the pedals since we can put more leg power into a longer travel linear pedal stroke than in a circular one. The pedals move up and down exerting leverage action at a plurality of distance from an axis that serves as a fulcrum to produce increased pressure over the opposite shorter end of the lever. The up and down movement of the levers or pedals assisted by our own gravity offers more human power than the traditional circular movement of the ordinary bicycle and it can be used to produce accelerated rotations per second by means of multiplying gears which in tern can be placed on the drive shaft of one or more alternators or electricity generator to be used to generate electricity that in turn can be used to power an electrical turbine to be in contact with the wheel or wheels that move the vehicle. It is envisioned the use of multiple other electronic devices such as converters, batteries, air conditionings, heaters, measuring devices or any other device other that could improve the vehicle performance and comfort. It is envisioned as well the use of one or more persons to power the mechanism.

1. A method of providing an efficient, human powered vehicle by means of a mechanical devise designed to increase the force of our muscle contraction by means of one or more levers that is (are) activated by pressing or stroking down assisted by the weight of our gravity and muscular force in such a way that the levers or pedals can move up and down close to a vertical pattern and where the place for exerting the human power is located at a long arm of the lever at a plurality of distance from a fulcrum while the short arm of said lever or pedal produce an increased force that is being used to move a rotational mechanism and where all the axis or axles of the mechanism are assisted by ball bearings in order to decrease the resistance imposed by the friction of the movement and where the bigger wheel of the rotational mechanism can be connected to an smaller wheel that in turn can move the wheels of the vehicle.

2. A human powered multiplying wheels accelerator for the specific purpose of generating electricity consisting of several axles each one containing one small wheel (example 3 cm of diameter) and one bigger wheel (example 300 cm of diameter) supported by a frame or points of support that are assisted by ball bearings and where the bigger wheel of the first axle is in contact with the smaller wheel of the second axle and the big wheel of the second axle is in contact with the smaller wheel of the third axle and subsequently as much as needed or as much as the resistance of the materials would allow us to keep multiplying and where the last axle of the mechanism may be connected to an alternator or electricity generator in order to generate electricity or for locomotion or for any other use or combination of uses that the electricity will allow. The diameters of the wheels is not to be taken in a limiting sense but just as an example because I envision the use of multiple combination of diameters or combination in the number of cogs, etc. without departing from the present invention.
A human powered multiplying wheels accelerator for the specific purpose of generating electricity as in claim 2 further comprising a connecting mechanism consisting or either direct dentate wheels or pulley or any other way of attachment. Further comprising to have several bars to serve as the base or attachment for the multiplying mechanism. Further comprising several benches or points of support aligned in several columns in order to attach the leverage activated mechanism to the generator of electricity.
A human powered multiplying wheels accelerator for the specific purpose of generating electricity further comprising a (optional) chamber made of any isolation material in order to create a vacuum inside by pumping the air out of said chamber which will decrease the resistance of the air within said accelerator and will help the free movement of the wheels inside and in turn will allow better generation of electricity.

3. A leverage activated-bicycle (LABY) designed to achieve higher velocity and performance than standard bicycles used today using the principle of the lever and the fulcrum where the point of pressure for the human power using our muscular strength and gravity is located close to the end of the long arm of a levers while the point of increased force after the fulcrum of the levers in the short arm of it, is where we can use that force by means or using a arm link and a arm shaft to exert rotational pressure over another axis that contains an inductor wheel of the same size or bigger than the standards used today and where we can connect said inductor wheel to an smaller induced one that moves the wheels that speed the vehicle.
LABY as in claim 2, further comprising a frame with a different configuration that the majority of the bicycle frames used today.
Said frame configured to be supported on the ground by at least two wheels rotatably attached to the same frame.
At least one top tube (which can be optionally expandable) and said top tube containing one seat binder bolt or more in order to add additional optional seats.
At least one down tube (which can be optionally expandable),
At least one head tube (which holds the steering of the vehicle)
At least one back tube (which binds the main axis of the pedal and the rotational device)
At least one middle tubes which may be optional) to provide additional support to the frame when more than one rider is on the vehicle.
At least one pivotal axis for the pedal located in an approximate point of the union of the down and the back tube
At least two pedals (which can be optionally expandable) in order to allow more space for optional more riders.
At least one axis for the crank arm of the inductor wheel (also known as the axis for the bigger plate of the chain or rotational mechanism) located in an approximate point close to the union of the top tube and the back tube.
At least a head tube containing ball bearings inside for the movement of a fork that holds the front wheel where said head tube also contains a head set for the attachment of said fork as well as a handle bar and all the other additions of a standard bicycle.
At least a chain stay and a pivotal axis stay that converge at a triangular shape in order to form a point for the attachment of the hub of the rear wheel.
At least a chain stay consisting of two bars (right side and left side) moving in a close to parallel direction towards the back. The chain stay are attached on One end, to the axis of the inductor wheel; and on the other end, to the attachment point for the rear wheel hub.
At least a pivotal axis stay consists of two bars (right side and left side) moving in a close to parallel direction towards the back departing from the attachment point of the pivotal axis on one end towards the attachment point for the rear wheel hub on the other end.
At least an arm link between the short arm of the pedal or lever and the crank arm of the big wheel.
At least a frame further comprising a seat-binding bolt for the insertion of the seat post, and the seat.
At least ball bearings at the points of friction of the pivotal axis, the axis of the big wheel, the axis of the attachment point of the crank arm to the link
arm and the axis for the attachment point of the link arm to the short arm of the pedal.
A LABY as in claim 2 further comprising brakes in communication with at least one wheel.
A LABY as in claim 2 further comprising a steering mechanism in communication with at least one wheel.
A LABY as in claim 2 further comprising an inductor wheel or big wheel located in the same axis of the rotational mechanism in communication with at least one gear, and a chain in communication with said gear and a main axis, wherein said chain translates motion from said gear to said main axis, which in turn causes the rotation of ate least on wheel.

3. A leverage activated-tricycle (LATY) designed to achieve higher velocity and performance than standard tricycles used today using the principle of the lever and the fulcrum where the point of pressure for the human power using our muscular strength and gravity is located close to the end of the long arm of a levers while the point of increased force after the fulcrum of the levers in the short arm of it is where we can use that force by means or using a arm link and a arm shaft to exert rotational pressure over another axis that contains an inductor wheel bigger than the standards used today and where we can connect said inductor wheel to an smaller induced one that moves the wheels that speed the vehicle.
Leverage-activated tricycle (LATY as in claim 7, further comprising a frame consisting of either concentric tubes that can be adjusted as desired in order to allow more riders or can be rigid, not expansible frame. And it is configured to be supported on the ground by at least three wheels rotatably attached to the same frame.
At least one top tube, one down tube, one head tube and one back tube where the pivotal axis for the pedal is located in a approximate point of the union of the down and the back tube and where the axis for the crank arm of the inductor wheel (also known as the axis for the bigger plate of the chain) is located in an approximate point close to the union of the top tube and the back tube.
At least a head tube containing ball bearings inside for the movement of a fork that holds the front wheel where said head tube also contains a head set for the attachment of said fork as well as a handle bar and all the other additions of a standard bicycle.
At least a chain stay and a pivotal axis stay that converge at a triangular shape in order to form a point for the attachment of the hubs of the rear wheels.
At least a chain stay consisting of two bars (right side and left side) moving in a close to parallel direction towards the back. The chain stay are attached on one end, to the axis of the inductor wheel; and on the other end, to the attachment point for the axis of the two rear wheels hubs.
At least two supporting tubes for holding the passenger seats
At least a pivotal axis stay consists of two bars (right side and left side) moving in a close to parallel direction towards the back departing from the attachment point of the pivotal axis on one end towards the attachment point for the axis of the two rear wheels hubs and at least an arm link between the short arm of the pedal or lever and the crank arm of the big wheel.
At least one chain and chain guard.
At least a frame further comprising a seat binding bolt for the insertion of the seat post, and the seat.
At least ball bearings at the points of friction of the pivotal axis, the axis of the big wheel, the axis of the attachment point of the crank arm to the link arm and the axis for the attachment point of the link arm to the short arm of the pedal.

5. A LATY as in claim 4 further comprising a suspension mechanism consisting of suspension springs in order to made smoother ride.

6. LATY as in claim 7 further comprising passenger seats.

7. A LATY as in claim 7 further comprising passengers cover or roof in order to protect from the elements.

8. Leverage activated vehicle moved by electricity generated by human power comprising a frame, levers and multiplying mechanism, and locomotion wheels in variable numbers as described before to be able to produce a wide range of high frequency revolutions (as explained before in detail) to be linked to one or more electricity generator to be linked directly or indirectly to the turbines or electrical motors that move the device. Further comprising one or more alternators or electricity generators, converters of electricity, transformers, voltage regulators, electrical switches, electric measuring devices, or any kind of other electric equipment to improve the function of the device.
Further comprising batteries to store the electricity.
Further comprising a electric motor or turbine to power the vehicle using the electricity generated by the human force and all the other components necessary to make the vehicle take off the ground. Further comprising a Crankshaft for the device that is moved by the leverage action of two or more crank arms that run along the pivot axis of the levers. Further comprising an electrical insulation cover for the metal parts that may have human contact in order to avoid electrocution.
